(19) United States
(12) Patent Application Publication
(10) Pub. No.: US 2016/0180029 A1
(43) Pub. Date: Jun. 23, 2016

(54) SYSTEM AND METHOD FOR PREDICTING PATIENT DISCHARGE PLANNING

(71) Applicant: General Electric Company, Schenectady, NY (US)

(72) Inventor: Lokesh Shanbhag, Bangalore (IN)

(21) Appl. No.: 14/735,576

(22) Filed: Jun. 10, 2015

(30) Foreign Application Priority Data
Dec. 23, 2014 (IN) 6497/CHE/2014

(51) Int. Cl. G06F 19/00

(52) U.S. Cl. CPC G06F 19/327; G06F 19/322

(57) ABSTRACT

A system for predicting patient discharge planning is disclosed. The system includes one or more memories configured to store patient data associated with a patient. One or more processors are configured to identify one or more criticality assessment parameter associated with the patient. A criticality assessment parameter is associated with health criticality of the patient. Discharge information associated with the patient is determined based on the one or more criticality assessment parameters. The discharge information is then presented.

### FIELD OF THE INVENTION

The subject matter disclosed herein relates to patient management in a hospital environment. More specifically the subject matter relates to planning of discharging of patients.

### BACKGROUND OF THE INVENTION

Patient management is a major concern in any hospital. Most of the hospitals may need to provide treatment to plethora of patients which may often become arduous due to lack of beds. In such instances some patients may be shifted to treat patients having an emergency requirement. Patient discharging is also currently performed in an adhoc fashion which adds to the complexity of patient management in the hospital. Present practice is that the medical practitioner or doctor checks the health condition of the patient and decides an approximate discharge date of the patient. However the health condition of the patient may vary i.e. it may be become worse or better and accordingly the discharge date may be postponed or preponed. The discharge date may vary from a day to day basis. Thus accurately or near accurately deciding on a discharge data seems to be difficult. As the discharge date is not predictable, managing admission of other patients may sometimes become difficult to lack of availability of beds. This unpredictability also affects the relatives of the patient as many events happen unplanned. Further most of these insurance companies need to know the discharge date of the patient beforehand so that patient treatment is covered by proper insurance.

Accordingly, a need exists to an improved method of planning of discharging of patients.

### SUMMARY OF THE INVENTION

The object of the invention is to provide an improved method of management of discharging of patients to another, which overcomes one or more drawbacks of the prior art. This is achieved by a system for predicting patient discharge planning including as defined in the independent claim.

One advantage with the disclosed is that the patient table with the flexible table top can carry the patient and the flexible table top along with the patient can be conveniently transferred to a different table or bed with less manual handling.

In an embodiment a system for predicting patient discharge planning is disclosed. The system includes one or more memories configured to store patient data associated with a patient. One or more processors are configured to identify one or more criticality assessment parameter associated with the patient. A criticality assessment parameter is associated with health criticality of the patient. Discharge information associated with the patient is determined based on the one or more criticality assessment parameters. The discharge information is then presented.

A method for predicting patient discharge planning is disclosed. The method includes storing patient data associated with a patient; identifying one or more criticality assessment parameters associated with the patient, a criticality assessment parameter is associated with health criticality of the patient; determining discharge information associated with the patient based on the one or more criticality assessment parameter; and presenting the discharge information.

A more complete understanding of the present invention, as well as further features and advantages thereof, will be obtained by reference to the following detailed description and drawings.

### BRIEF DESCRIPTION OF THE DRAWINGS

FIG. 1 is a schematic illustration of a perspective view of a patient table assembly for holding and transferring a patient in accordance to an embodiment;

FIG. 2 illustrates a block diagram showing clinical categories assigned to the patient and historical information used for predicting discharge information of the patient in accordance to an embodiment;

FIG. 3 illustrates a mapping table showing the clinical categories and associated minimum number of days of treatment according to an exemplary embodiment.

FIG. 4 illustrates multiple beds having patients with a display device assigned to each bed according to an embodiment.

FIG. 5 is a schematic illustration of a user interface element 700 depicting comparison of a current health condition of a patient with a previous health condition and a desired health condition of the patient in accordance with an embodiment.

FIG. 6 illustrates a medical device communicating with a cloud environment according to an embodiment; and

FIG. 7 illustrates a method of predicting patient discharge planning according to an embodiment.

### DETAILED DESCRIPTION OF THE INVENTION

In the following detailed description, reference is made to the accompanying drawings that form a part hereof, and in which is shown by way of illustration specific embodiments that may be practiced. These embodiments are described in sufficient detail to enable those skilled in the art to practice the embodiments, and it is to be understood that other embodiments may be utilized and that logical, mechanical and other changes may be made without departing from the scope of the embodiments. The following detailed description is, therefore, not to be taken as limiting the scope of the invention.

As discussed in detail below, embodiments of the invention including a system for predicting patient discharge planning is disclosed. The system includes one or more memories configured to store patient data associated with a patient. One or more processors are configured to identify one or more criticality assessment parameter associated with the patient. A criticality assessment parameter is associated with health criticality of the patient. Discharge information associated with the patient is determined based on the one or more criticality assessment parameters. The discharge information is then presented.

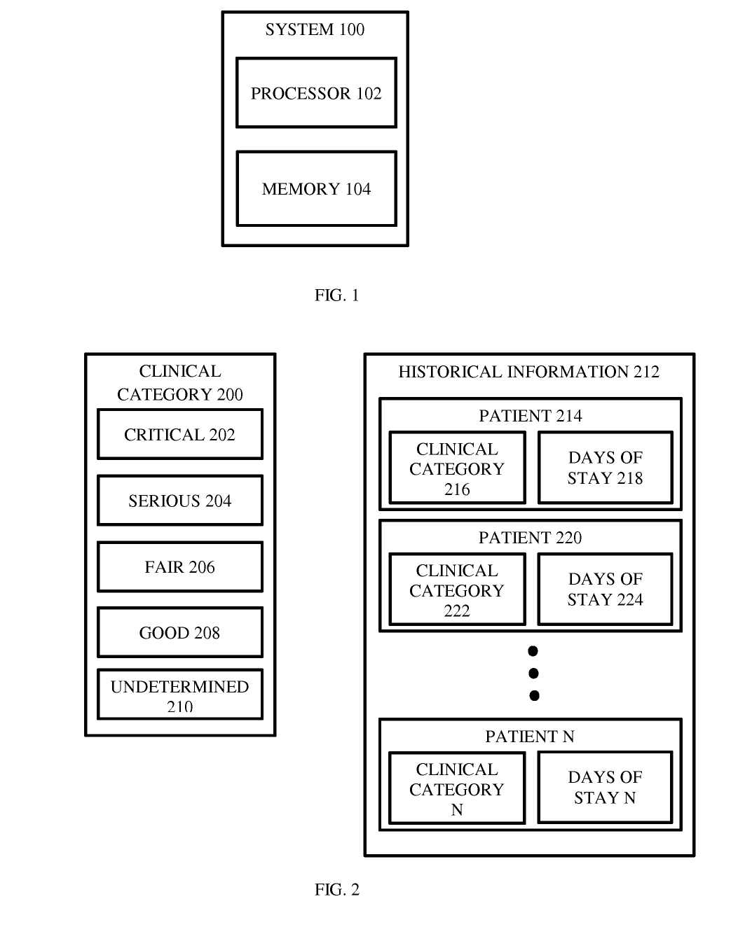

FIG. 1 is a perspective view of a system 100 for predicting patient discharge planning in accordance with an embodiment. When a patient admits to a hospital, patient data associated with the patient are stored. The patient data is stored in one or more memories such as a memory 102. The patient data may include but not limited to age, gender and name of the patient, health parameters of the patient, health history of the patient, any results of health checkup performed on the patient, and so on. The health parameters may include but are not limited to blood pressure rate, heart rate, body temperature, respiratory rate, pulse pressure, neurological activities, respiratory frequencies, saturated percentage of oxygen in the blood (SP02), carbon dioxide measurement, cardiac output, end-tidal carbon dioxide concentration (EtCO2) and airway respiratory rate (AWRR), systolic pressure rate, diastolic pressure rate and so on. The system 100 includes a processor 104 configured to identify one or more criticality assessment parameters of the patient. The one or more criticality assessment parameters include a current health state of the patient, a health history of the patient, a type of illness of the patient, and medical treatment undergone on the patient. The medical treatment undergone of the patient may include a surgery performed on the patient, medicines provided to the patient, and so on. These criticality assessment parameters are identified or determined based on the patient data. The processor 104 determines discharge information of the patient based on one or more criticality assessment parameters. The discharge information includes a discharge schedule of the patient. The discharge schedule may include discharge date that indicates when the patient will be discharged from the hospital. The discharge information is then presented to medical practitioner and relatives of the patient in the hospital.

In an embodiment based on the health condition of the patient and the criticality assessment parameters, a clinical category 200 (shown in FIG. 2) is assigned to the patient. The health condition of the patient is determined based on the health parameters. The clinical category may indicate a criticality level associated with a health condition of the patient. Multiple clinical categories may be stored in the memory 102 from which a clinical category may be selected and assigned to each patient. The multiple clinical categories may include but are not limited to critical 202, serious 204, fair 206, good 208 and undetermined 210. Each clinical category may be associated with a set of health parameters. Each health parameter may also have an associated alarm signal. Each clinical category differs from the other clinical category based on severity of health condition of the patient. In an embodiment the clinical category critical 202 indicates that the patient's condition is catastrophic, whereas serious 204 indicate that the condition is life threatening. Further the clinical categories fair 206 indicates that the condition is curable or treatable, good 208 indicates the condition is improvable and undetermined 210 indicates the patient is awaiting the medical practitioner's assessment. In an embodiment, each health parameter associated with a clinical category may have a threshold parameter value. The categories differ from each other in terms of health parameters and threshold parameter values associated with the health parameters. For example, a patient classified in a critical category may have more number of health parameters or different health parameters that need to be monitored as compared to other clinical categories. Further, one or more threshold parameter values of the critical category may be higher as compared to one or more threshold parameter values associated to the corresponding health parameters in other clinical categories.

In another example a patient may be classified in an undetermined category when few health parameters and associated parameter values are satisfactory and other health parameters and their parameter values are not satisfactory or not clearly determinable or have frequent fluctuations. In such a situation, a health condition of the patient may likely worsen or improve thus may not be clearly defined. In an embodiment the multiple clinical categories may include clinical categories dependent on treatment or surgical procedure conducted on the patient. For example, a patient who has undergone a heart surgery may need to be monitored. In this scenario a clinical category including a set of health parameters and threshold parameter values related to heart may be applied. Thereafter the patient may be monitored based on the applied clinical category.

In order to determine an appropriate clinical category to be assigned to the patient, the processor(s) 104 may determine whether the set of health parameters associated with each clinical category matches with health parameters that need to be monitored for a patient. Further a parameter value associated with a health parameter determined by a medical expert may be compared with the threshold parameter value associated with a corresponding health parameter of a clinical category. For example if the monitored parameter value is above a threshold parameter value then the patient may be classified in a clinical category that is related to the threshold parameter value.

Now to determine the discharge information of the patient, in an embodiment a criticality assessment parameter of the patient is mapped with a criticality assessment parameter of another patient. For example a current health condition of the patient is mapped to a health condition of another patient having a same medical condition e.g. a heart surgery. In another instance the current health condition of the patient may be compared with health conditions of multiple patients in the past who were having the same medical condition. The health conditions of these patients may be part of historical information 212 that may be stored. The historical information 212 includes criticality assessment parameters of the multiple patients and their treatment schedule and discharge information in the hospital may be stored in the memory 102. Based on the mapping the discharge date of the patient is identified. In this example for the patient who has undergone a heart surgery may require certain days of observation in the hospital and hence the patients having similar medical condition and their length of stay in the hospital enables to predict the discharge date. However the discharge date can vary based on any change in medical condition of the patient. The change may be severe or better based on which the initial discharge date may be postponed or preponed. Hence the discharge date is predicted based on real time medical condition of the patient. In an embodiment the medical condition of the patient may be analyzed at predefined instances such as after every predefined time interval.

In another instance the processor 104 may map a current clinical category of the patient with clinical category of multiple patients in the past. Each clinical category may have an associated medication to be performed and minimum number of days of stay in the hospital which may be predefined. This may be predefined by the medical practitioner in the hospital or may be common according to procedures in medical field. As shown in FIG. 2 the historical information 212 includes data associated with multiple patients 212, 220 and N who were admitted and treated in the hospital in the past. For instance the patient 212 may have a clinical category 214 when in hospital and the patient 212 stayed in the hospital for days of stay 218 e.g. 14 days. Similarly the patient 220 may have a clinical category 222 and stayed in the hospital for days of stay 224 e.g. 30 days. In this case the clinical category 222 may be more critical than the clinical category 214. For example the clinical category 222 may be critical 202 and the clinical category 214 may be fair 206. However in another embodiment the clinical category 222 may be serious 204 and the patient this category may have undergone a heart surgery. Whereas a patient having the clinical category 214 may be critical 202 but may be having a breathing difficulty and in ventilator. In this scenario, the patient who is in the clinical category 222 i.e. serious 204 may need to stay in the hospital more as compared to the patient in the critical 202 as the patient may recover faster when compared to the patient who has undergone heart surgery. So the medical treatment undergone on the patient is also considered along with their clinical category for determining or predicting the days of stay in the hospital.

In an embodiment the processor 104 may be also configured to measure the intensity of an alarm signal associated with each health parameter of a clinical category for predicting the discharge date. Taking an example, if a patient is in a clinical category i.e. fair 206 and all alarm signals associated with all health parameters associated with this category starts raising alarms then the discharge date may be more or extended as compared to having the clinical category as fair 206 and only few or no alarm signals raising alarms. Another instance is where the patient may be assigned a clinical category i.e. critical 202 and only few alarm signals may raise alarms. In this case the discharge date may be earlier than another patient assigned a clinical category i.e. critical 202 and all the alarm signals may raise alarms. This because when the patient is assigned the clinical category i.e. critical 202 and all alarm signals raise then time for recovery may be more and hence the discharge date will be longer. So even when two patients are in same clinical category their discharge date may be different as the processor 104 also considers the alarm signals associated with the health parameters for each clinical category. In yet another embodiment the processor 104 is further configured to determine an intensity level associated with an alarm signal for a health parameter and then predict the discharge date based on the intensity level. The intensity level may vary from low intensity, high intensity and highest intensity. The intensity level may indicate a criticality level of a health parameter. Further in another instance each health parameter may have an associated weightage, for example one health parameter may be less critical than other health parameters and hence if alarm signal of this health parameter shows up then the processor 104 may not give as much weightage as other health parameters. Accordingly the processor 104 may predict the discharge date of the patient based on the alarm signals.

The clinical categories of multiple patients may be stored as historical information in the memory 102. The clinical categories of these patients stored as history may also have associated number of days of stay at hospital by each patient in the past. In the past the patient having a particular clinical category and medical condition had to stay in the hospital for a certain number of days. Based on the historical information and patient's clinical category, the discharge date of the patient is determined or predicted. The discharge date and other discharge information are presented to the medical practitioner and relatives of the patient.

The historical information 212 may also include a type of treatment performed on each patient for example a type of surgery, severity of the medical condition of the patient, age and gender of the patient even though these are not presented in FIG. 2. The type of surgery may include for example but not limited to, ENT surgery, a heart surgery, a pediatric surgery, a vascular surgery, an oral surgery and a general surgery.

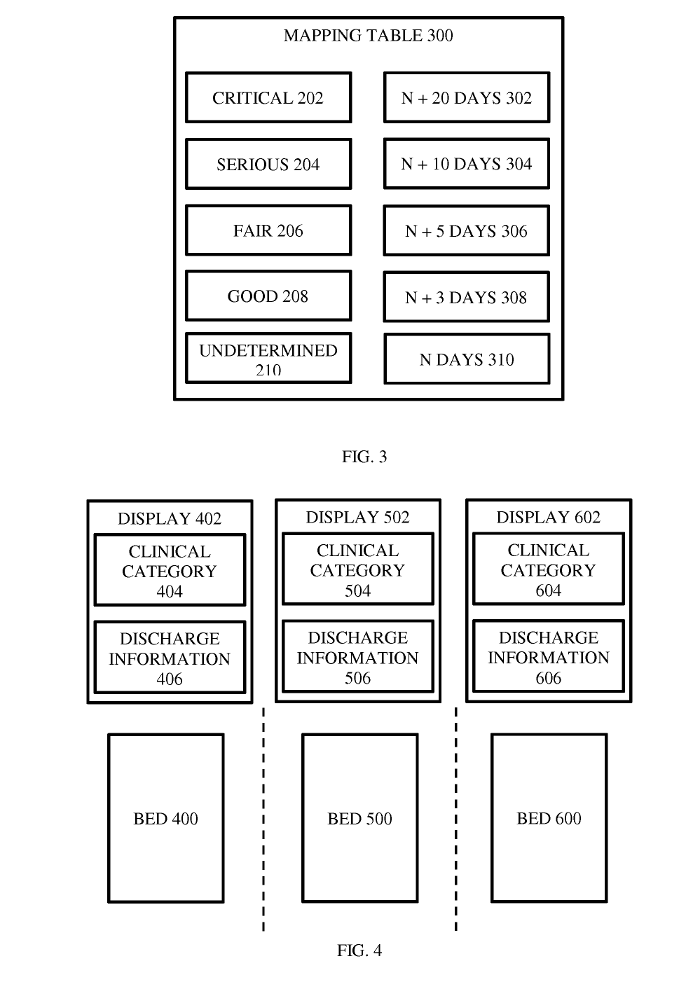

As discussed earlier each clinical category may have an associated minimum number of days of treatment in the hospital for a patient of respective clinical category. For instance when the patient is admitted to the hospital based on the clinical category assigned to the patient the number of days may be checked from a mapping table according to an embodiment. FIG. 3 illustrates a mapping table 300 showing the clinical categories and associated minimum number of days of treatment according to an exemplary embodiment. The mapping table 300 includes multiple clinical categories such as the critical 202, the serious 204, the fair 206, the good 208 and the undetermined 210. The clinical categories provided here are merely exemplary, so other clinical categories may be also possible for example but not limited to deceased, critical but stable, satisfactory, comfortable, stable, progressing well and/or discharged/moved. If a patient has the clinical category as critical 202 then the patient needs to stay in the hospital for N+20 days 302. The N+20 days may be presented to the patient, the medical practitioner and the relatives of the patient. The N here indicates the date of admission of the patient into the hospital. Whereas if the patient is assigned a clinical category i.e. serious 204 then the patient may need to stay in the hospital for N+10 days which is lesser as compared to the clinical category i.e. critical 202. If the patient is assigned the clinical category i.e. fair 206 then the patient needs to stay in the hospital for N+5 days. Whereas the clinical category i.e. good 208 may be assigned to the patient and then the patient may have to stay in the hospital for N+3 days. Moreover when the patient is assigned the clinical category i.e. the undetermined 210 then the patient may need to stay in the hospital for N days 310. If the patient's clinical category moves from critical 202 to fair 206 then the mapping table 300 may be used to identify the number of days and predict the discharge date.

In another embodiment a mapping table may include an illness type and a corresponding type of surgery and stay duration in the hospital. Here once the patient's illness type is known, the mapping table can be used by the processor 104 to predict the discharge date using the date of admission and stay duration associated with the illness type and surgery type.

FIG. 4 illustrates multiple beds having patients with a display device assigned to each bed according to an embodiment. For instance beds 400, 500 and 600 may have patients and may be provided a display device. The bed 400, the bed 500 and the bed 600 are provided a display device 402, a display device 502 and a display device 604 respectively. The display device 402 displays a criticality category 404 associated with a patient in the bed 400. Further the display device 502 displays a criticality category 504 associated with a patient in the bed 500. The display device 602 displays a criticality category 604 associated with a patient in the bed 600. Based on the criticality category of each patient and historical information the discharge information of the patients is predicted. The display device 402 presents discharge information 404 of the patient in the bed 400. The display device 502 presents discharge information 504 of the patient in the bed 500. Further the display device 602 presents discharge information 604 of the patient in the bed 600. The discharge information 404, the discharge information 504 and the discharge information 604 may be predicted in real time manner. The discharge information includes a discharge date of a patient. Thus discharge date of the patients in the bed 400, the bed 500 and the bed 500 are displayed so that the patients know about the discharge timing and their relatives are also aware.

The clinical category of the patient may change at any time due to variation in the medical condition of the patient. For instance the patient in the bed 400 may have the clinical category 404 as fair initially and then may change to serious at any moment. In such a situation the discharge date initially predicted based on the clinical category 404 as fair will be increased. In another situation the patient in the bed 500 may have a clinical category 504 as critical initially and then may change to fair after some time when responding to treatment. Here the discharge date may be decreased as compared to the number of days predicted initially. Thus when there is a shift in the clinical category of the patient from present one to another accordingly the processor 104 may alter the discharge date by adding or reducing the number of days of stay on the hospital to an initial predicted discharge date.

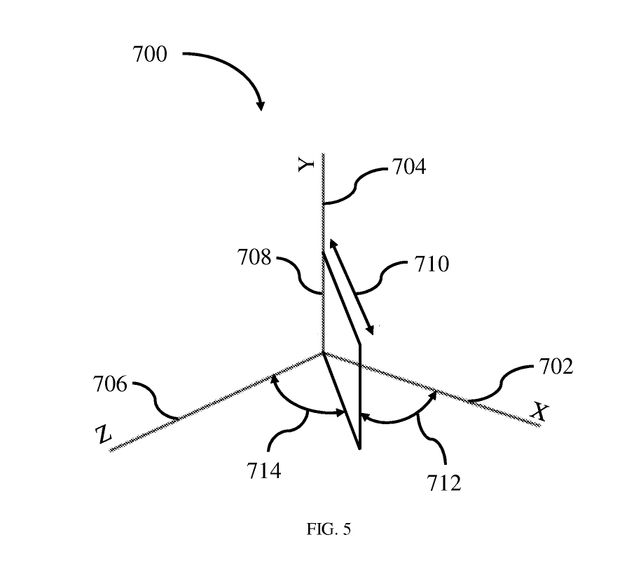

FIG. 5 is a schematic illustration of a user interface element 700 depicting comparison of a current health condition of a patient with a previous health condition and a desired health condition of the patient in accordance with an embodiment. The user interface element 700 may be a three dimensional coordinate system having a X-coordinate 702, a Y-coordinate 704 and a Z-coordinate 706. The X-coordinate 702, the Y-coordinate 704 and the Z-coordinate 706 may be associated with the current health condition, the desired health condition and the previous health condition of the patient respectively. However the user interface element 700 may be depicted in any other manner to indicate the comparison between various health conditions of the patient. The user interface element 700 may be presented in a user interface. In the user interface element 700 the comparison of the current health condition of the patient with the previous health condition and the desired health condition of the patient may be depicted in the form of a degree of deviation. An amount of degree of deviation may be represented in the form of an area 708. The deviation of the current health condition from the desired health condition and the previous health condition is indicated by an arrow 710, an arrow 712 and an arrow 714. For example in order to determine a deviation in the current health condition a waveform of current heart rate is compared with a desired waveform and a previous waveform. Based on this comparison an amount of closeness or deviation in the present health condition is determined. The amount of closeness or deviation of the present health condition is indicated by the area 708. Thus the area 708 shown by the user interface element 700 may enable the nurse or the medical expert to determine the effort required in order to reach the desired health condition for the patient. Based on the degree of deviation of the health condition, the patient may be classified in a clinical category of the multiple clinical categories. Moreover the degree of deviation may also enable the nurse or the medical expert to decide on the treatment that can be provided to shift the patient to the desired health condition. The processor 104 may be configured to analyze the amount of deviation of the current health condition from the desired health condition to predict the discharge date and present.

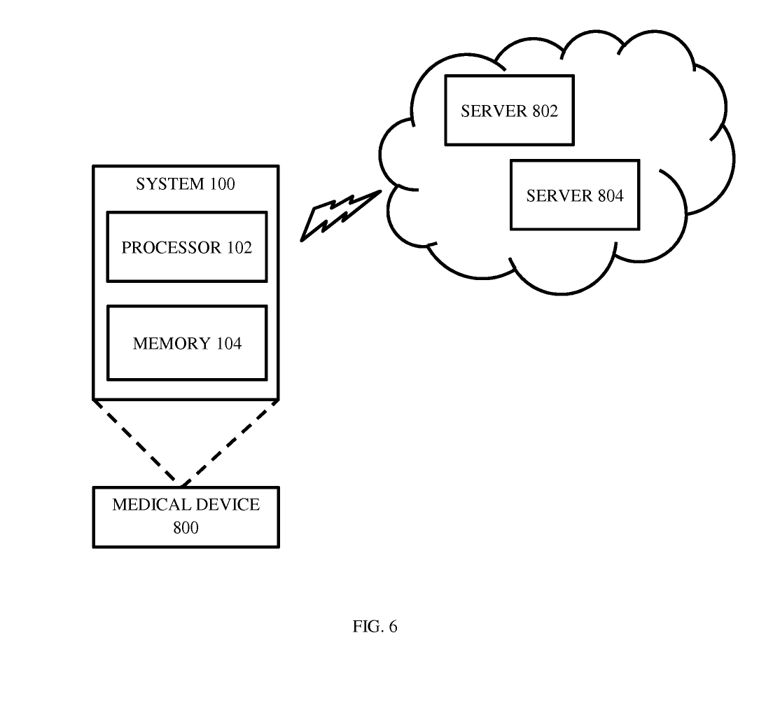

FIG. 6 illustrates a medical device 800 communicating with a cloud environment 802 according to an embodiment. The medical device 800 may include but are not limited to a patient monitoring device, an ultrasound device, a X-ray device, a magnetic resonance (MR) imaging device, a ECG device, a computed tomography (CT) imaging device, a positron emission tomography (PET) imaging device, medical image storing device and so on. The cloud environment 802 may include servers capable of storing the historical information of patients. In an embodiment the historical information may be associated with patients treated in a particular hospital. In another instance the historical information may include criticality assessment parameters of the multiple patients and their treatment schedule and discharge information in the hospital, a type of treatment performed on each patient for example a type of surgery, severity of the medical condition of the patient, age and gender of the patient. When the patient data is entered into the medical device 800. The processor 102 communicates with the cloud environment 802 for predicting the discharge date of the patient based on a clinical category of the patient. The processor 102 also evaluates the patient data. The clinical category may be send by the processor 102 to the server 802 to determine number of days of stay at hospital for the clinical category. A mapping table similar to the mapping table 300 may be stored in one of the server 802 and the server 804. The cloud environment 802 is shown to include two servers however it may be envisioned that multiple servers may be present and communicate to each other for performing numerous operations.

In another embodiment, the mapping table may be retrieved from the cloud environment 802 and received by the processor 102. The processor 102 then maps the clinical category with clinical categories in the mapping table to predict the discharge date. In an embodiment the processor 102 may receive only a portion of the mapping table that is corresponding to the clinical category of the patient.

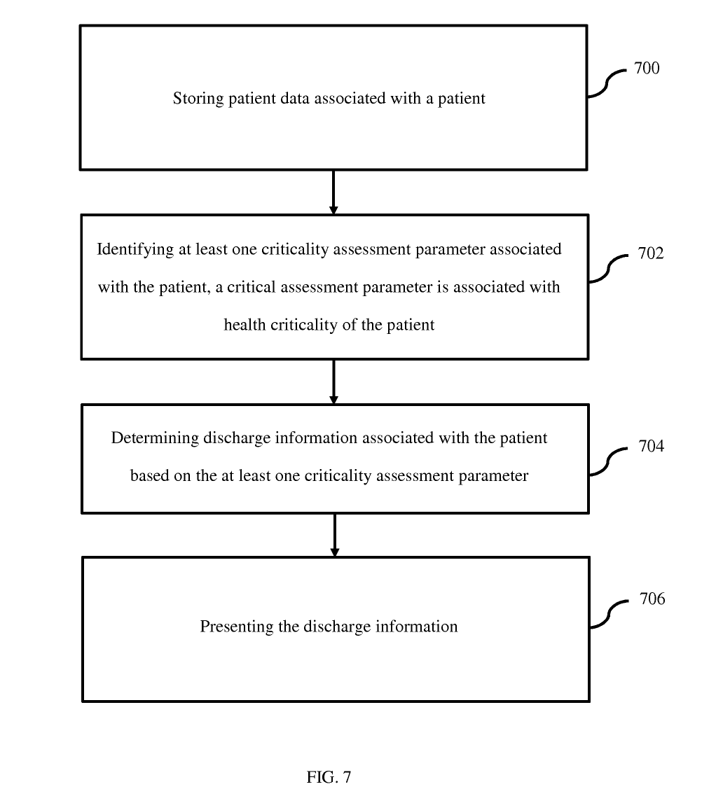

FIG. 7 illustrates a method 900 of predicting patient discharge planning according to an embodiment. In this method 900, at step 902 patient data associated with a patient is stored. The patient may reach the hospital for admission and the patient data may be stored in the hospital database system and also stored in any medical devices that may be required. Thereafter one or more criticality assessment parameters associated with the patient are identified at step 904. The criticality assessment parameters are associated with the health criticality of the patient. The one or more criticality assessment parameters include a current health state of the patient, a health history of the patient, a type of illness of the patient, and medical treatment undergone on the patient. The medical treatment undergone of the patient may include a surgery performed on the patient, medicines provided to the patient, and so on. These criticality assessment parameters are identified or determined based on the patient data.

At step 906, discharge information associated with the patient is determined based on the one or more criticality assessment parameter. In an embodiment a criticality assessment parameter of the patient is mapped with a criticality assessment parameter of another patient. For example a current health condition of the patient is mapped to a health condition of another patient having a same medical condition e.g. a heart surgery. In another instance the current health condition of the patient may be compared with health conditions of multiple patients in the past who were having the same medical condition. The health conditions of these patients may be part of historical information that may be stored. The historical information includes criticality assessment parameters of the multiple patients and their treatment schedule and discharge information in the hospital may be stored in the memory of the medical device. Based on the mapping the discharge schedule including discharge date of the patient is identified.

In another embodiment a current clinical category of the patient may be mapped with clinical category of multiple patients in the past. Each clinical category may have an associated medication to be performed and minimum number of days of stay in the hospital which may be predefined. This may be predefined by the medical practitioner in the hospital or may be common according to procedures in medical field.

In an embodiment an intensity of an alarm signal associated with each health parameter of a clinical category is measured for predicting the discharge information. Taking an example, if a patient is in a clinical category i.e. fair and all alarm signals associated with all health parameters associated with this category starts raising alarms then the discharge date may be more or extended as compared to having the clinical category as fair and only few or no alarm signals raising alarms. Another instance is where the patient may be assigned a clinical category i.e. critical and only few alarm signals may raise alarms. In this case the discharge date may be earlier than another patient assigned a clinical category i.e. critical and all the alarm signals may raise alarms. This because when the patient is assigned the clinical category i.e. critical and all alarm signals raise then time for recovery may be more and hence the discharge date will be longer. So even when two patients are in same clinical category their discharge date may be different as the alarm signals associated with the health parameters for each clinical category are also considered. In yet another embodiment an intensity level associated with an alarm signal for a health parameter is determined and then the discharge date is predicted based on the intensity level. The intensity level may vary from low intensity, high intensity and highest intensity. The intensity level may indicate a criticality level of a health parameter. Further in another instance each health parameter may have an associated weightage, for example one health parameter may be less critical than other health parameters and hence if alarm signal of this health parameter shows up then it may not give as much weightage as other health parameters. Accordingly the discharge date of the patient is predicted based on the alarm signals.

Each clinical category may have an associated minimum number of days of treatment in the hospital for a patient of respective clinical category. For instance when the patient is admitted to the hospital based on the clinical category assigned to the patient the number of days may be checked from a mapping table according to an embodiment. The mapping table may include multiple clinical categories such as critical, serious, fair, good and undetermined. If the patient's clinical category moves from critical to fair then the mapping table may be used to identify the number of days and predict the discharge date. The mapping table may also further include an illness type and a corresponding type of surgery and stay duration in the hospital. Here once the patient's illness type is known, the mapping table can be used to predict the discharge date using the date of admission and stay duration associated with the illness type and surgery type.

From the foregoing, it will appreciate that the above disclosed a system for predicting patient discharge planning to provide numerous benefits to healthcare enterprises, such as improved way of managing the patients in a hospital environment. This system enables to predict and present the discharge schedule of the patient beforehand to the medical practitioner, patient and relatives of the patients in real-time. Predicting the discharge schedule beforehand enables any insurance companies to provide financial coverage for the patient more effectively as they can pre-plan. Further the hospital management can effectively manage the patients because they are able to pre-plan availability of beds for any new patients. The medical attenders or nurses can also pre-plan their activities if the discharge schedule of the patients are predicted and presented to them.

This written description uses examples to disclose the invention, including the best mode, and also to enable any person skilled in the art to practice the invention, including making and using any computing system or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

I claim:

1. A system for predicting patient discharge planning, the system comprises:
at least one memory configured to store patient data associated with a patient; and
at least one processor configured to:
identify at least one criticality assessment parameter associated with the patient, a criticality assessment parameter is associated with health criticality of the patient;
determine discharge information associated with the patient based on the at least one criticality assessment parameter; and
present the discharge information.

2. The system of claim 1, wherein the discharge information comprises a discharge schedule of the patient.

3. The system of claim 1, wherein a criticality assessment parameter of the at least one criticality assessment parameter is associated with one of a current health state of the patient, a health history of the patient, a type of illness of the patient, and a medical treatment undergone on the patient.

4. The system of claim 3, wherein the at least one processor is further configured to assign a clinical category to the patient based on the at least one criticality assessment parameter associated with the patient, wherein a clinical category differs from another clinical category based on severity of health state of the patient.

5. The system of claim 3, wherein the at least one processor is further configured to:
map at least one of the at least one criticality assessment parameter and the clinical category associated with the patient with at least one criticality assessment parameter and a clinical category associated with another patient;
map the patient data of the patient with patient data of the another patient; and
identify the discharge information of the patient based on the mapping.

6. The system of claim 4, wherein the at least one criticality assessment parameter, the clinical category and the patient data associated with another patient is of a historical information, the historical information comprising at least one criticality assessment parameter, clinical categories and patient data associated with a plurality of patients.

7. The system of claim 5, wherein the at least one memory stores the historical information.

8. The system of claim 5, wherein the historical information is stored in a cloud environment.

9. The system of claim 3, wherein each clinical category having at least one alarm signal indicating a health parameter of the patient, each alarm signal having an associated criticality level.

10. The system of claim 9, wherein the at least one processor is further configured to identify the at least one criticality assessment parameter by:
accessing at least one of change in a clinical category of the patient, immune capability of the patient and clinical response of the patient; and
determining the at least one criticality assessment parameter based on the assessment.

11. The system of claim 10, wherein the change in the clinical category of patient is based on a number of alarm signals, at least one of criticality level and severity of an alarm signal, and type of alarm signals.

12. A method for predicting patient discharge planning, the method comprising:
storing patient data associated with a patient;
identifying at least one criticality assessment parameter associated with the patient, a criticality assessment parameter is associated with health criticality of the patient;
determining discharge information associated with the patient based on the at least one criticality assessment parameter; and
presenting the discharge information.

13. The method of claim 12, wherein the discharge information comprises a discharge schedule of the patient.

14. The method of claim 11, wherein a criticality assessment parameter of the at least one criticality assessment parameter is associated with one of a current health state of the patient, a health history of the patient, a type of illness of the patient, and a medical treatment undergone on the patient.

15. The method of claim 14 further comprises assigning a clinical category to the patient based on the at least one criticality assessment parameter associated with the patient, wherein a clinical category differs from another clinical category based on severity of health state of the patient.

16. The method of claim 14 further comprises:
mapping at least one of the at least one criticality assessment parameter and the clinical category associated with the patient with at least one criticality assessment parameter and a clinical category associated with another patient;
mapping the patient data of the patient with patient data of the another patient; and
identifying the discharge information of the patient based on the mapping.

17. The method of claim 15, wherein the at least one criticality assessment parameter, the clinical category and the patient data associated with another patient is of a historical information, the historical information comprising at least one criticality assessment parameter, clinical categories and patient data associated with a plurality of patients, wherein the method comprises storing the historical information in a cloud environment.

18. The method of claim 15, wherein each clinical category having at least one alarm signal indicating a health parameter of the patient, each alarm signal having an associated criticality level.

19. The method of claim 18, wherein identifying the at least one criticality assessment parameter comprises:
accessing at least one of change in a clinical category of the patient, immune capability of the patient and clinical response of the patient; and
determining the at least one criticality assessment parameter based on the assessment.

20. The method of claim 19, wherein the change in the clinical category of patient is based on a number of alarm signals, at least one of criticality level and severity of an alarm signal, and type of alarm signals.
